(19) United States
(12) Patent Application Publication
(10) Pub. No.: US 2023/0367157 A1
(43) Pub. Date: Nov. 16, 2023

(54) DIMMING DEVICE, MANUFACTURING METHOD THEREOF, AND SMART WINDOW

(71) Applicants: Toyo Limited, Osaka (JP); Tohoku University, Miyagi (JP)

(72) Inventors: Yuichi Momoi, Osaka (JP); Takahiro Ishinabe, Miyagi (JP); Hideo Fujikake, Miyagi (JP); Yosei Shibata, Miyagi (JP)

(21) Appl. No.: 18/245,070

(22) PCT Filed: Sep. 8, 2021
(86) PCT No.: PCT/JP2021/033050

§ 371 Date: Mar. 13, 2023

(30) Foreign Application Priority Data
Sep. 24, 2020 (JP) 2020-160183

(51) Int. Cl. G02F 1/1337; G02F 1/1334; E06B 9/24

(52) U.S. Cl. CPC G02F 1/133788; G02F 1/1334; E06B 9/24; G02F 2202/022; G02F 2202/04; E06B 2009/2464

(57) ABSTRACT

A dimming device includes a pair of transparent substrates and a liquid crystal layer sandwiched between the pair of transparent substrates. The liquid crystal layer includes a vertical alignment agent, and the dimming device has a drive voltage of 25 V or less for providing a haze of 80% or more.

### FIELD OF THE INVENTION

The present invention relates to a dimming device, a manufacturing method thereof, and a smart window.

### BACKGROUND OF THE INVENTION

A dimming device can change a transmittance of light by various environments such as light, heat, electricity and gas, and external stimuli, and is used for smart windows and the like. For example, an electrochromic system, a thermochromic system, a liquid crystal system, and the like have been proposed as typical light dimming systems for smart windows. Among these systems, the liquid crystal system using a polymer dispersed liquid crystal, which is a composite material of a liquid crystal compound and a macromolecule, changes a refractive index difference between the liquid crystal compounds or the liquid crystal compound and the macromolecule by controlling an alignment direction of the liquid crystal compound by an electric field, so that a transmissive state and a scattering state of incident light can be switched. This liquid crystal system has a faster response and can switch the transmissive state and the scattering state of incident light at a higher speed than the other systems, so that it is being used in a wide range of applications, such as privacy windows that block visibility, and projection screens.

There are a normal mode and a reverse mode as drive systems for the dimming device of the liquid crystal system. The normal mode becomes a transmissive mode in a state where a voltage is applied and a scattering mode in a state where no voltage is applied, whereas the reverse mode becomes a scattering mode in a state where a voltage is applied and a transmissive mode in a state where no voltage is applied. Since the reverse mode becomes a transmissive mode in a state where no voltage is applied, it has advantages of lower power consumption and better safety in the event of power cut, than those of the normal mode.

The dimming device in the reverse mode requires the liquid crystal compound to be vertically aligned to the transparent substrate. As a means for the vertical alignment, an alignment film made of a material such as polyimide have been used. The alignment film is formed by coating a transparent substrate with a solution obtained by dissolving the material of the alignment film in an organic solvent, and then heating the transparent substrate. However, there is a problem that the step of forming such an alignment film is complicated and the manufacturing cost is higher. There is also a problem that the material of the transparent substrate is limited because of the use of the solvent and the heat treatment, and it is difficult to manufacture a flexible dimming device using an inexpensive resin substrate.

Therefore, a dimming device has been proposed that includes a liquid crystal layer (a dimming layer) containing a vertical alignment agent for vertically aligning the liquid crystal compound to the transparent substrate, instead of the alignment film (for example, Patent Literatures 1 and 2).

### PRIOR ART

### Patent Literatures

[Patent Literature 1] Japanese Patent Application Publication No. 2019-527381 A
[Patent Literature 2] WO 2018/105726 A1

### SUMMARY OF THE INVENTION

### Problem to be Solved by the Invention

The conventional dimming device having the liquid crystal layer containing the vertical alignment agent has a problem of higher power consumption due to its higher drive voltage. In fact, the dimming devices described in Patent Literatures 1 and 2 require a drive voltage of 30 V or more in order to achieve a haze of 80% or more.

Further, the conventional dimming devices cannot use existing inexpensive electronic components with lower withstand voltage performance, so they also have a problem of increased product costs.

The present invention has been made to solve the above problems. An object of the present invention is to provide an inexpensive dimming device with a lower drive voltage, a manufacturing method thereof, and a smart window.

### Means for Solving the Problem

As a result of intensive studies for a dimming device in which a liquid crystal layer (a dimming layer) is sandwiched between a pair of transparent substrates, the present inventors have found that the above problems can be solved by having the following specific composition, and have completed the present invention.

Thus, the present invention relates to a dimming device comprising a pair of transparent substrates and a liquid crystal layer sandwiched between the pair of transparent substrates, wherein the liquid crystal layer comprises a vertical alignment agent, and wherein the dimming device has a drive voltage of 25 V or less for providing a haze of 80% or more.

The present invention also relates to a method for manufacturing the dimming device, the method comprising a step of producing a liquid crystal cell by arranging a liquid crystal composition comprising a liquid crystal compound and a vertical alignment agent between a pair of transparent substrates.

Furthermore, the present invention relates to a smart window comprising the dimming device.

### Effects of Invention

According to the present invention, it is possible to provide an inexpensive dimming device with a lower drive voltage, a manufacturing method thereof, and a smart window.

### BRIEF DESCRIPTION OF THE DRAWINGS

FIG. 1 is a schematic cross-sectional view of a dimming device according to Embodiment 1 of the present invention;

FIG. 2 is a schematic cross-sectional view of another dimming device according to Embodiment 1 of the present invention;

FIG. 3 is a schematic cross-sectional view of a dimming device according to Embodiment 2 of the present invention;

FIG. 4 is a graph showing a relationship between a voltage and a haze in a dimming device manufactured in each of Example 1 and Comparative Example 1;

FIG. 5 is observation images for substrate surfaces of Samples 1 and 2 with laser microscopes;

FIG. 6 is scanning electron microscope images for substrate surfaces of Samples 1 and 2 with a scanning electron microscope;

FIG. 7 is a graph showing a relationship between a voltage and a haze in a dimming device manufactured in Example 2;

FIG. 8 is a graph of minute current measurements versus triangular wave applied voltages for liquid crystal cells A to D; and

FIG. 9 shows impurity ion densities of liquid crystal cells A to D calculated from the graph of FIG. 8.

### DETAILED DESCRIPTION OF THE INVENTION

Hereinafter, embodiments of the present invention will be specifically described. It is to understand that the present invention is not limited to the following embodiments, and those which have appropriately added changes, improvements and the like to the following embodiments based on knowledge of a person skilled in the art without departing from the spirit of the present invention fall within the scope of the present invention.

### Embodiment 1

A dimming device according to Embodiment 1 of the present invention includes a polymer dispersed liquid crystal layer as a liquid crystal layer.

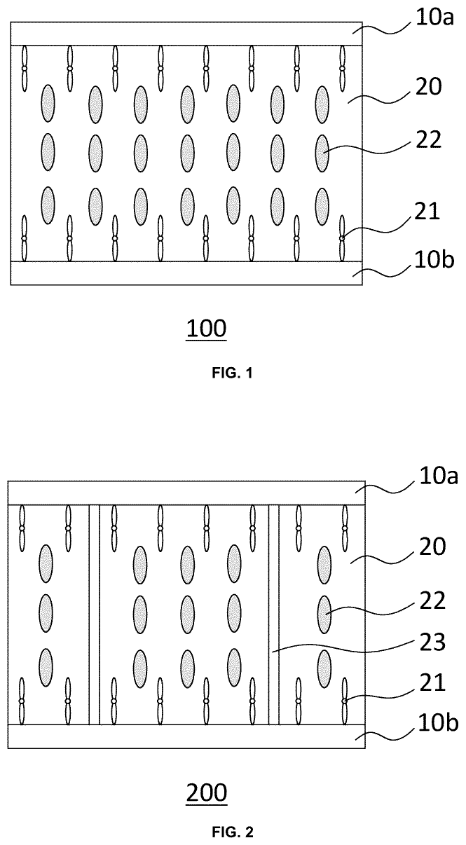

FIG. 1 is a cross-sectional schematic view of a dimming device according to Embodiment 1 of the present invention.

As shown in FIG. 1, a dimming device 100 according to Embodiment 1 of the present invention includes a pair of transparent substrates 10a, 10b and a polymer dispersed liquid crystal layer 20 sandwiched between the pair of transparent substrates 10a, 10b.

The pair of transparent substrates 10a, 10b that can be used herein includes, but not limited to, substrates known in the art such as resin substrates and glass substrates. Among them, the transparent substrates 10a, 10b are preferably the resin substrates. The use of the resin substrate can provide a flexible dimming device 100.

The resin substrate can be formed using, for example, a polyester-based resin, a (meth)acrylic resin, an olefinic resin, a cyclic olefinic resin, a polycarbonate-based resin, a polyurethane-based resin, a cellulose-based resin, a styrene-based resin, or the like. Specific examples of the polyester-based resin include polyethylene terephthalate (PET), polybutylene terephthalate (PBT), polyethylene naphthalate (PEN), copolymerized PETs (PET-Gs) including an alicyclic dicarboxylic acid or an alicyclic diol including isophthalic acid, cyclohexane rings or the like, other polyesters, and copolymers and blends thereof. These are used alone or in combination of two or more.

The materials of the pair of transparent substrates 10a, 10b may be the same as or different from each other.

Each of the pair of transparent substrates 10a, 10b preferably has a light transmittance (at a light wavelength of 550 nm) of 80% or more, and more preferably 85% or more, and even more preferably 90% or more. The light transmittance in such a range can achieve excellent transparency in a transmissive mode.

Each of the pair of transparent substrates 10a, 10b may have a thickness of, for example, 10 to 1200 μm, and preferably 20 to 500 μm, and more preferably 50 to 300 μm, although not particularly limited thereto.

The pair of transparent substrates 10a, 10b are provided with a transparent electrode(s) (not shown).

The transparent electrode may be provided so that a voltage can be applied to the polymer dispersed liquid crystal layer 20. For example, the transparent electrodes may be provided on the surfaces of both of the pair of transparent substrates 10a, 10b on the polymer dispersed liquid crystal layer 20 side, or the transparent electrode may be provided on the surface of one of the pair of transparent substrates 10a, 10b on the polymer dispersed liquid crystal layer 20 side. When the transparent electrodes are provided on both of the pair of transparent substrates 10a, 10b, the transparent electrodes can be planar electrodes capable of applying the voltage perpendicularly to the polymer dispersed liquid crystal layer 20. When the transparent electrode is provided on one of the pair of transparent substrates 10a, 10b, the transparent electrode can be an interdigited electrode (comb-shaped electrode) capable of applying the voltage in parallel to the polymer dispersed liquid crystal layer 20.

The transparent electrode can be formed using a metal oxide such as indium tin oxide (ITO), zinc oxide (ZnO), tin oxide (SnO₂), and the like. The transparent electrode may also be formed using a silver nanowire (AgNW), a carbon layer such as carbon nanotubes (CNTs), an organic conductive film, a metal layer, or a laminate thereof. The transparent electrode can be patterned into a desired shape depending on the purposes. For example, by patterning the transparent electrode into a vertical stripe shape, a horizontal stripe shape, or a lattice shape, the dimming device 100 can be suitably provided with a blind function.

The pair of transparent substrates 10a, 10b may optionally be provided with functional layers (functional films) known in the art.

For example, the pair of transparent substrates 10a, 10b can have alignment films on the surfaces on the polymer dispersed liquid crystal layer 20 side. In the dimming device 100 according to Embodiment 1 of the present invention, the vertical alignment of the liquid crystal compound 22 can be controlled by a vertical alignment agent 21. Therefore, the alignment film may not be formed, but the vertical alignment of the liquid crystal compound 22 may be controlled in combination with the alignment film. However, it is preferable that the pair of transparent substrates 10a, 10b do not have the alignment film, because a drive voltage of the dimming device 100 may be increased by forming the alignment film.

The polymer dispersed liquid crystal layer 20 contains the vertical alignment agent 21.

Here, the “vertical alignment agent 21” as used herein means an agent having a function of vertically aligning the liquid crystal compound 22 to the pair of transparent substrates 10a, 10b.

Although the vertical alignment agent 21 is not particularly limited, it is preferably a material that can be adsorbed to the pair of transparent substrates 10a, 10b. By using such a vertical alignment agent 21, the vertical alignment agent 21 tends to exist at an interface between each of the pair of transparent substrates 10a, 10b and the polymer dispersed liquid crystal layer 20, so that the drive voltage can be lowered.

Also, the vertical alignment agent 21 is preferably compatible with the polymer dispersed liquid crystal layer 20.

As used herein, the term “vertical alignment agent 21 compatible with the polymer dispersed liquid crystal layer 20” means that when the vertical alignment agent 21 is added to the polymer dispersed liquid crystal layer 20 and a temperature is increased to a temperature equal to or more than a phase transition temperature of the polymer dispersed liquid crystal layer 20 in an oven to form an isotropic phase, the vertical alignment agent 21 is dissolved (i.e., a mixture of the polymer dispersed liquid crystal layer 20 and the vertical alignment agent 21 is transparent), and no precipitation of the vertical alignment agent 21 is observed even after returning to room temperature (for example, 25° C.).

The use of the vertical alignment agent 21 compatible with the polymer dispersed liquid crystal layer 20 can lead to an increased transmittance in the transmissive mode.

Examples of the vertical alignment agent 21 that can be used herein include macromolecules having a branched structure containing at least one mesogenic group in at least one side chain. The macromolecule preferably contains one or more atoms that can be adsorbed to the pair of transparent substrates 10a, 10b by intermolecular force.

As used herein, the term “macromolecule” means a substance having a molecular weight of 1000 or more, preferably 1500 or more, more preferably 2000 or more, as measured by MALDI-TOF-MS.

The mesogenic groups are not particularly limited, and those known in the art can be used. Examples of the mesogenic groups include phenyl benzoate, biphenyl, cyanobiphenyl, terphenyl, cyanoterphenyl, phenylbenzoate, azobenzene, diazobenzene, anilinebenzylidene, azomethine, azoxybenzene, stilbene, phenylcyclohexyl, biphenylcyclohexyl, phenoxyphenyl, benzylideneaniline, benzylbenzoate, phenylpyrimidine, phenyldioxane, benzoylaniline, tolan and derivatives thereof.

Examples of the atoms that can be adsorbed to the pair of transparent substrates 10a, 10b by intermolecular forces include, but not limited to, N (nitrogen), O (oxygen), P (phosphorus), S (sulfur), and halogen. Among them, the atom is preferably N.

Specific examples of the vertical alignment agent 21 include dendrimers and dendrons. As used herein, the term “dendrimer” refers to a dendritic macromolecule having a structure that is regularly branched from the center, and is composed of a central moiety called a core and a side chain moiety called a dendron. As used herein, the term “dendron” refers to a dendritic macromolecule having a structure that is regularly branched from the center, as with the dendrimer, but expands (extends) only in one direction from the center (a focal point).

The structure of the dendrimer is not particularly limited, but it can be represented by formula (I):

[symbol]

CH₂—CH₂—N [symbol] CH₂—CH₂—CH₂—N [symbol] CH₂—CH₂—CH₂—N—R¹₂)₂)₂)₂ (I)

In the above formula (I), R¹ is represented by formula (II):

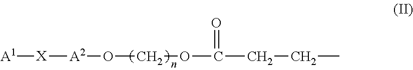

In the above formula (II), A¹ is:

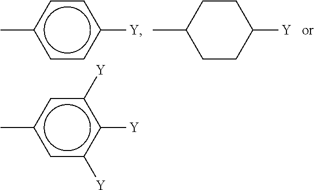

in which Y is an alkyl group or alkoxy group having 1 to 12 carbon atoms, or fluorine; and X is a direct bond, a —COO— group or a —N═N— group; and A² is:

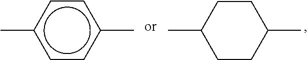

n is an integer from 3 to 12.

The dendrimer having such a structure can be obtained by allowing a polyfunctional amine compound that provides the core moiety to react with an acrylate ester derivative that provides the side chain moiety in an organic solvent.

Examples of the polyfunctional amine compounds include Polypropylene tetramine Dendrimer, Generation 1.0, Polypropylene octaamine Dendrimer, Generation 2.0, and commercially available products such as DAB-Am-4 and DAB-Am-8 from Sigma-Aldrich can also be used. Moreover, the polyfunctional amine compound can also be synthesized using ethylenediamine and acrylonitrile as starting materials.

The acrylate ester derivative may be appropriately selected according to the dendrimer to be synthesized. For example, when synthesizing the dendrimer represented by the above formula (I), a compound represented by the following formula (IV) can be used as a raw material.

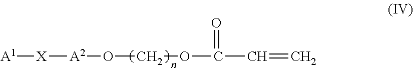

In the above formula (IV), X, A¹, A² and n are as defined above.

The reaction ratio of the acrylate ester derivative to the polyfunctional amine compound is 1.0 to 3.0 mol, preferably 1.1 to 1.5 mol, of the acrylate ester derivative per one mol of the polyfunctional amine compound.

As the organic solvent, conventionally known solvents can be used, for example, including halogenated hydrocarbon-based solvents such as 1,2-dichloroethane and chloroform; ketone-based solvents such as acetone, methyl ethyl ketone, methyl isobutyl ketone and cyclohexanone; cyclic ether-based solvents such as tetrahydrofuran and dioxane; aromatic hydrocarbon-based solvents such as toluene and xylene; and aprotic polar solvents such as N-methyl-2-pyrrolidone, N,N-dimethylformamide and N,N-dimethylacetamide. These organic solvents can be used alone or in combination of two or more.

Further, an amount of the organic solvent may be appropriately adjusted depending on the amount of the polyfunctional amine compound and the acrylate ester derivative, although not particularly limited thereto.

The reaction temperature is −50 to 150° C., and preferably 25 to 80° C. If the reaction temperature is less than −50° C., the reaction rate may significantly decrease. If the reaction temperature is more than 150° C., the stability of the polyfunctional amine compound and the acrylate ester derivative may decrease.

The reaction time is 2 to 200 hours, and preferably 48 to 100 hours. If the reaction time is less than 2 hours, the reaction may not sufficiently proceed. If the reaction time is more than 200 hours, it takes too long period of time, which is not practical.

At the end of the reaction, the solvent can be removed to provide a desired dendrimer. Further, the product may be purified by adding a poor solvent such as methanol, ethanol, isopropyl alcohol, hexane, and toluene, and heating it, and removing a supernatant.

The structure of the dendron is not particularly limited, but it can be represented by formula (III):

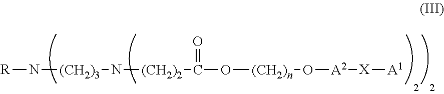

In the formula (III), R is hydrogen, an alicyclic group, an aromatic group, or a HO—(CH₂)ₘ— group, in which m is an integer from 2 to 6. Here, examples of the alicyclic group include, but not limited to, a cyclopropyl group, a cyclopentyl group, a cyclohexyl group, a cycloheptyl group, a cyclooctyl group, an adamantly group, a norbornyl group, an isobornyl group, a camphanyl group, a dicyclopentyl group, a tricyclodecanyl group, tetracyclododecyl group, an androstanyl group, and the like. Examples of the aromatic group include, but not limited to, a phenyl group, a naphthyl group, a biphenyl group, a triphenyl group, a binaphthyl group, an anthracenyl group, and a fluorenyl group. Further, in the formula (III), A¹ is:

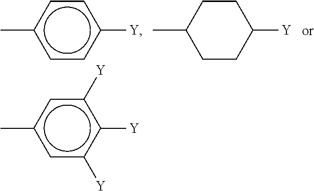

in which Y is an alkyl group or alkoxy group having 1 to 12 carbon atoms, or fluorine; and A² is:

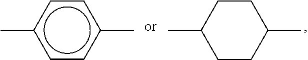

X is a direct bond, a —COO— group or a —N═N— group, and n is an integer from 3 to 12.

The dendron used in the present invention can be synthesized using known methods described in various literatures. In general, a compound having an amino group(s) providing the focal point may be allowed to react with a compound that binds to that compound to provide the branch moiety of the dendron. For example, an acrylate ester derivative that provides the branch moiety of the dendron may be allowed to react with a compound having a terminal amino group that reacts with the acrylate ester derivative and an amino group(s) providing the focal point, in an organic solvent.

The compound having the amino group providing the focal point is not particularly limited, and it may be appropriately selected depending on the dendron to be synthesized. Further, when adjusting the generation of the dendron (order of branch), the compound having the amino group providing the focal point may be allowed to react with acrylonitrile or the like to form a branched structure, and a reducing agent such as lithium aluminum hydride may be then used to convert the nitrile to an amine.

For example, when synthesizing the dendron having the above general formula (III), a compound having the following general formula (V) can be used:

RN—((CH₂)₃—NH₂)₂ (V)

in which R is as defined above.

Here, the compound represented by the above formula (V) as described above can be synthesized by reaction of R—NH₂, acrylonitrile and (CH₂═CHCN), followed by conversion of the nitrile to an amine using a reducing agent such as lithium aluminum hydride.

The acrylate ester derivative that provides the dendron branch moiety is not particularly limited, but it may be appropriately selected depending on the dendron to be synthesized. For example, when synthesizing the dendron having the above general formula (III), an acrylate ester derivative having the following general formula (VI) can be used as a raw material:

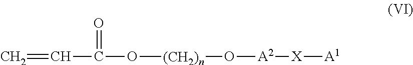

In the formula, A¹, A², X and n are as defined above.

A reaction ratio of the acrylate ester derivative (e.g., the compound of the general formula (VI)) to the compound having the amino group providing the focal point (e.g., the compound of the general formula (V)) must be appropriately adjusted depending on the type of raw materials to be used. In general, 1 to 10 mol of the acrylate ester derivative may be used per 1 mol of the compound having the amino group providing the focal point.

The organic solvent used in the above reaction is not particularly limited, and organic solvents known in the art can be used. Examples of the organic solvents include halogenated hydrocarbon-based solvents such as 1,2-dichloroethane and chloroform; ketone-based solvents such as acetone, methyl ethyl ketone, methyl isobutyl ketone and cyclohexanone; cyclic ether-based solvents such as tetrahydrofuran and dioxane; aromatic hydrocarbon-based solvents such as toluene and xylene; and aprotic polar solvents such as N-methyl-2-pyrrolidone, N,N-dimethylformamide and N,N-dimethylacetamide. These organic solvents can be used alone or in combination of two or more.

Also, the amount of the organic solvent may be appropriately adjusted depending on the type and amount of the raw material used, and it is not particularly limited.

The reaction temperature is −50 to 150° C., and preferably 25 to 80° C. If the reaction temperature is less than −50° C., the reaction rate may significantly decrease. Moreover, if the reaction temperature is more than 150° C., the stability of the raw material may be lowered.

The reaction time is 2 to 200 hours, and preferably 48 to 100 hours. If the reaction time is less than 2 hours, the reaction may not sufficiently proceed. If the reaction time is more than 200 hours, it takes too long period of time, which is not practical.

At the end of the reaction, the solvent can be removed to obtain a desired dendron. Alternatively, the dendron may be purified by adding a poor solvent such as methanol, ethanol, isopropyl alcohol, hexane, and toluene, heating it, and removing a supernatant.

A copolymer of a monomer having at least one mesogenic group and a monomer containing one or more atoms capable of being adsorbed to the transparent substrates 10a, 10b by intermolecular force, or the like, is useful for use as the other vertical alignment agent 21. Specific examples of such a copolymer include copolymers published in “Homeotropic Orientation of Nematic Liquid Crystals Induced by Side-Chain Liquid Crystalline Copolymers Having Tertiary Amino Groups” in the 27^{th} International Liquid Crystal Conference (ILCC2018), and copolymers published in “Homeotropic Orientation of Nematic Liquid Crystals Induced by a copolymer of (Meth)acrylate Having a Mesogen with 2-(Dimethylamino)ethyl(meth)acrylate” in IPOMY (The Second International Conference of Polymeric and Organic Materials in Yamagata University, 2019).

The vertical alignment agents 21 in the polymer dispersed liquid crystal layer 20 are mainly present at interfaces between each of the pair of transparent substrates 10a, 10b and the polymer dispersed liquid crystal layer 20, and allows the liquid crystal compound 22 to be vertically aligned to the pair of transparent substrates 10a, 10b.

Therefore, the content of the vertical alignment agent 21 in the polymer dispersed liquid crystal layer 20 may be an amount such that the vertical alignment agent 21 is allowed to be present at the interfaces. That is, the content of the vertical alignment agent 21 in the polymer dispersed liquid crystal layer 20 cannot be uniquely defined because it depends on the areas of the pair of transparent substrates 10a, 10b in contact with the polymer dispersed liquid crystal layer 20, but it is generally 0.01 to 50% by mass.

The polymer dispersed liquid crystal layer 20 is a layer formed from a composite material of the liquid crystal compound 22 and a macromolecule. The liquid crystal compound 22 is present in a phase-separated or dispersed state in a network structure formed by the macromolecule (hereinafter referred to as a macromolecule network). The polymer dispersed liquid crystal layer 20 may be formed from a PDLC (Polymer Dispersed Liquid Crystal) having a structure in which the liquid crystal compound 22 is dispersed in the macromolecule, or PNLC (Polymer Network Liquid Crystal) having a structure in which the liquid crystal compound 22 is filled in gaps between the network macromolecules, or the like, although not particularly limited thereto.

The polymer dispersed liquid crystal layer 20 may have a thickness of, for example, 3 to 30 μm, and preferably 10 to 25 μm, although not particularly limited thereto. The control to such a thickness leads to easy control of a haze of 80% or more at a lower drive voltage when switching to the scattering mode.

The liquid crystal compound 22 forming the polymer dispersed liquid crystal layer 20 that can be used herein includes, but not limited to, non-polymerized liquid crystal compounds 22 known in the art. The liquid crystal compound 22 may be either nematic, smectic, or cholesteric, but it may preferably be nematic. The use of the nematic liquid crystal compound 22 can achieve excellent transparency in the transmissive mode. Also, the anisotropy of the dielectric constant of the liquid crystal compound 22 may be either positive or negative.

Examples of the liquid crystal compound 22 include low-molecular liquid crystal compounds exhibiting a nematic phase or a smectic phase at room temperature or at an elevated temperature, such as cyanobiphenyl-based, cyanophenylcyclohexane-based, cyanophenyl ester-based, phenyl benzoate-based, phenylpyrimidine-based compounds, and mixtures thereof, as described in Japanese Patent Application Publication No. H11-174211 A. Examples of such low molecular liquid crystal compounds include low-molecular liquid crystal compounds such as biphenyl-based, phenylbenzoate-based, cyclohexylbenzene-based, azoxybenzene-based, azobenzene-based, azomethine-based, terphenyl-based, biphenylbenzoate-based, cyclohexylbiphenyl-based, phenylpyrimidine-based, cyclohexylpyrimidine-based, and cholesterol-based compounds. These low-molecular liquid crystal compounds may be used alone or in combination of two or more.

The macromolecule making up the polymer dispersed liquid crystal layer 20 is a polymer or a crosslinked product of at least one monomer component. The monomer component can be appropriately selected according to the light transmittance, the refractive index of the liquid crystal compound 22, and the like. Typical monomer components include polymerizable liquid crystal monomers (which may contain bifunctional or higher cross-linking monomers) and active energy ray-curable resin monomers. Examples of the active energy ray-curable resin include (meth)acrylic resins, silicone-based resins, epoxy-based resins, fluorine-based resins, polyester-based resins, and polyimide-based resins. The monomer components may be used alone or in combination of two or more, preferably in combination of two or more. The use of the combination of two or more monomer components can form both the macromolecule network and a partition wall 23 as described below. Moreover, the monomer component preferably contains at least one liquid crystal monomer from the viewpoint of facilitating matching of the refractive index to that of the liquid crystal compound 22.

The liquid crystal monomers are not particularly limited, and liquid crystal monomers known in the art can be used. Examples of the liquid crystal monomers that can be used herein include polymerizable compounds (monomers) and the like, as described in JP 2002-533742 (WO 00/37585), EP 358 208 (U.S. Pat. No. 5,211,877), EP 66 137 (U.S. Pat. No. 4,388,453), WO 93/22397, EP 0 261 712, DE 19504224, DE 4408171, and GB 2280445. Such polymerizable compounds are commercially available (for example, product name: LC242 from BASF; product name E7 from Merck; product name LC-Sillicon-CC3767 from Wacker-Chemie; product name RSM257 (1,4-bis[4-(3-acryloyloxypropoxy)benzoyloxy]-2-methylbenzene) from Tokyo Chemical Industry Co., Ltd (TCI), and the like). Therefore, such commercially available products can be used.

The polymer dispersed liquid crystal layer 20 may further contain components known in the art, depending on the purpose.

For example, the polymer dispersed liquid crystal layer 20 may further contain a chiral agent. The use of the chiral agent can render the liquid crystal compound 22 cholesteric orientation. The type and amount of the chiral agent to be added can be appropriately determined depending on desired set values such as helical pitches.

The polymer dispersed liquid crystal layer 20 may also contain an antioxidant, a dye, or the like. In particular, the dimming device 100 generally performs switching from transparent (incident light transmissive state) to opaque (incident light scattering state), and the use of a dichroic dye as the dye can perform switching from transparent (incident light transmissive state) to black (incident light absorption state). It should be noted that the present inventors have experimentally confirmed that the addition of the dichroic dye is not substantially affected on the effects of the present invention (in particular, the effect of reducing the drive voltage of the dimming device 100).

The content of the known component in the polymer dispersed liquid crystal layer 20 is not particularly limited, but it may be, for example, 10% by mass or less.

The polymer dispersed liquid crystal layer 20 containing the vertical alignment agent 21 can be formed by reaction of a liquid crystal composition containing the liquid crystal compound 22, the monomer component, and the vertical alignment agent 21 by an active energy ray.

The mass ratio of the monomer component and the liquid crystal compound 22 in the liquid crystal composition is, for example, 5:95 to 30:70, and preferably 10:90 to 20:80, although not particularly limited thereto. The control of the mass ratio of the monomer component and the liquid crystal compound 22 to such a range results in easy control of the haze to 80% or more at a lower drive voltage when switching to the scattering mode.

The content of the vertical alignment agent 21 in the liquid crystal composition is, for example, 0.01 to 50% by mass, and preferably 0.05 to 30% by mass, and more preferably 0.1 to 10% by mass, although not particularly limited thereto.

The liquid crystal composition may further contain the above known components depending on the purpose. Also, the liquid crystal composition may further contain a polymerization initiator. The type and amount of the polymerization initiator to be added can be appropriately determined depending on the types and compositions of the monomer components. The content of these components in the liquid crystal composition is not particularly limited, but it may be, for example, 10% by mass or less.

As shown in FIG. 2, the polymer dispersed liquid crystal layer 20 can include a partition wall 23 for partitioning the polymer dispersed liquid crystal layer 20 into a plurality of regions.

The structure of the partition wall 23 is not particularly limited, but it preferably has a lattice-shaped continuous structure when the polymer dispersed liquid crystal layer 20 is viewed in the plane, and is provided so as to connect the pair of transparent substrates 10a, 10b.

The provision of the partition wall 23 leads to a difficulty to change the thickness of the polymer dispersed liquid crystal layer 20, and can prevent the liquid crystal compound 22 from flowing or leaking due to displacement of the pair of transparent substrates 10a, 10b due to bending. The partition wall 23 can also function as a spacer that maintains a distance between the pair of transparent substrates 10a, 10b. Therefore, the provision of the partition wall 23 facilitates manufacturing of the flexible dimming device 200.

As used herein, the partition wall 23 having the “lattice-shaped continuous structure” refers to partitions that extend in a plurality of directions and are periodically arranged when the polymer dispersed liquid crystal layer 20 is viewed in the plane. The number of extending directions of the partition wall 23 is not particularly limited, but it may preferably be two directions (in this case, the lattice shape is quadrangular) or three directions (in this case, the lattice shape is triangular or hexagonal), and more preferably the two directions.

Although the width of the partition wall 23 is not particularly limited, it may be, for example, 3 to 50 μm, and preferably 5 to 30 μm, and more preferably 8 to 20 μm.

The dimming device 100, 200 according to Embodiment 1 of the present invention has a drive voltage of 25 V or less, preferably 20 V or less, more preferably 15 V or less, for providing a haze of 80% or more. The drive voltage in such a range can be said to be the lower drive voltage. On the other hand, the lower limit of the drive voltage is not particularly limited, but it may be 3V or 5V, for example.

The haze and drive voltage can be measured by the methods described in Examples below.

The dimming device 100, 200 according to Embodiment 1 of the present invention can further include members known in the art as required.

For example, between the pair of transparent substrates 10a, 10b can be a spacer to maintain a predetermined distance. Also, between the pair of transparent substrates 10a, 10b can be a sealing portion for sealing the polymer dispersed liquid crystal layer 20. Furthermore, various layers such as a hard coat layer, a protective layer, and an adhesive layer can be provided on the surfaces of the pair of transparent substrates 10a, 10b opposite to the polymer dispersed liquid crystal layer 20.

The dimming device 100, 200 according to Embodiment 1 of the present invention having the structure as described above can be manufactured by a method including the steps of: producing a liquid crystal cell by arranging a liquid crystal composition containing a liquid crystal compound 22, at least one monomer component, and a vertical alignment agent 21 between a pair of transparent substrates 10a, 10b; and irradiating the liquid crystal cell with an active energy ray.

The method for producing the liquid crystal cell by arranging the liquid crystal composition between the pair of transparent substrates 10a, 10b is not particularly limited, and any method known in the art can be used.

For example, the liquid crystal composition may be injected between the pair of transparent substrates 10a, 10b using capillary action.

Alternatively, after one transparent substrate 10a (or transparent substrate 10b) is coated with the liquid crystal composition to form a coated layer, the other transparent substrate 10b (or transparent substrate 10a) may be laminated on the coated layer. Examples of the coating method that can be used herein include known methods such as a roll coating method, spin coating method, wire bar code method, dip coating method, die coating method, curtain coating method, spray coating method, and knife coating method.

By irradiating the liquid crystal cell produced as described above with the active energy ray, the at least one monomer component in the liquid crystal composition is polymerized or crosslinked to form the polymer dispersed liquid crystal layer 20.

The active energy ray that can be used herein includes, but not limited to, ionizing radiation such as ultraviolet rays, electron beams, α-rays, β-rays, and γ-rays. Among these, the ultraviolet ray is preferably used as the active energy ray. The active energy ray may be applied to the entire surface of the liquid crystal cell, or may be applied only to a predetermined position of the liquid crystal cell.

The irradiation conditions for the active energy ray may be appropriately adjusted depending on the type of the active energy ray and the liquid crystal composition (particularly, the monomer component) to be used, and they are not particularly limited.

For example, when the ultraviolet ray is used as the active energy ray, the irradiation conditions for the ultraviolet ray can be: an illuminance of preferably 1 to 300 mW/cm², and more preferably 10 to 150 mW/cm², and an irradiation time of preferably 1 to 30 minutes, and more preferably 1 to 15 minutes. As a light source, for example, a high-pressure mercury lamp, a low-pressure mercury lamp, a metal halide lamp, a UV-LED, or the like can be used.

Since the at least one monomer component is polymerized or crosslinked by the irradiation with the active energy ray, the polymer dispersed liquid crystal layer 20 formed contains a macromolecule (a polymer or a crosslinked product of the monomer component), the liquid crystal compound 22 and the vertical alignment agent 21. The liquid crystal compound 22 is present in a phase-separated or dispersed state in the macromolecule network structure formed by the macromolecule.

When the monomer component includes a liquid crystal monomer, the liquid crystal macromolecule is obtained by the above polymerization or cross-linking. It is preferable that the liquid crystal macromolecule is aligned in a predetermined direction and the alignment state is fixed. By fixing the alignment state of the liquid crystal macromolecule, the switching between the transmissive mode and the scattering mode can be suitably performed by changing the alignment state of the liquid crystal compound 22. Such a liquid crystal macromolecule can be obtained by aligning a liquid crystal monomer(s) (which may include bifunctional or higher cross-linking monomers) and then polymerizing or cross-linking the liquid crystal monomer(s). Here, the polymerization or cross-linking results in the formation of the macromolecule, and the cross-linking results in the formation of the macromolecule network structure, and these are non-liquid crystalline. Therefore, the resulting liquid crystal macromolecule does not generate, for example, a transition to a liquid crystal phase, a glass phase or a crystal phase due to a change in a temperature, which is specific for the liquid crystalline compound.

When manufacturing the dimming device 200 having the polymer dispersed liquid crystal layer 20 and provided with the partition wall 23, the irradiation with active energy ray (e.g., ultraviolet ray) is performed in two stages. More particularly, the irradiation with the active energy ray includes a first irradiation with the active energy ray for selectively irradiating a predetermined portion of the liquid crystal cell and a second irradiation with the active energy ray for irradiating the entire surface of the liquid crystal cell.

Such a two-stage irradiation method can form the partition wall 23 in a predetermined portion. The selective irradiation in the first irradiation with the active energy ray can be performed using a mask having a predetermined opening pattern. For example, the liquid crystal cell is irradiated with the active energy ray through a mask having a grid-shaped opening pattern as viewed in the plane, and the entire surface of the liquid crystal cell is then irradiated with the active energy ray after removing the mask, thereby forming the polymer dispersed liquid crystal layer 20 and the partition wall 23 partitioning the polymer dispersed liquid crystal layer 20 into a plurality of regions. Such a structure can provide the dimming device 200 having improved impact resistance and mechanical strength.

The dimming device 100, 200 according to Embodiment 1 of the present invention can suitably be used in a reverse mode in which the driving method becomes a transmissive mode in a state where a voltage is not applied and becomes a scattering mode in a state where a voltage is applied, because the vertical alignment agent 21 vertically aligns the liquid crystal compound 22 to the pair of transparent substrates 10a, 10b.

The dimming device 100, 200 in the reverse mode becomes the scattering mode because a difference between refractive indices of the macromolecule and the liquid crystal compound 22 in the polymer dispersed liquid crystal layer 20 increases by applying a voltage higher than a threshold at which the Frederick transition occurs. On the other hand, that device becomes the transmissive mode because the difference between the refractive indices of the macromolecule and the liquid crystal compound 22 in the polymer dispersed liquid crystal layer 20 decreases by stopping the application of the voltage. Since the method has a faster response speed than other methods, it can switch between the transmissive mode and the scattering mode at a higher speed.

The dimming device 100, 200 according to Embodiment 1 of the present invention uses the polymer dispersed liquid crystal layer 20 containing the vertical alignment agent 21 as the liquid crystal layer, and controls the drive voltage to 25 V or less to increase the haze to 80% or more, so that the drive voltage is lower than that of any of the conventional dimming devices. Further, the dimming device 100, 200 according to the embodiment of the present invention may not be provided with the alignment film, and can use inexpensive resin substrates as the pair of transparent substrates 10a, 10b, so that the manufacturing costs can be reduced. Therefore, the dimming device 100, 200 according to Embodiment 1 of the present invention can be used for various applications such as electronic blinds, projection screens, dimming windows, smart windows, liquid crystal shutters, and light guide plates. Among these, the dimming device 100, 200 according to Embodiment 1 of the present invention is particularly suitable for use in the smart windows.

### Embodiment 2

A dimming device according to Embodiment 2 of the present invention includes a nematic liquid crystal layer as a liquid crystal layer.

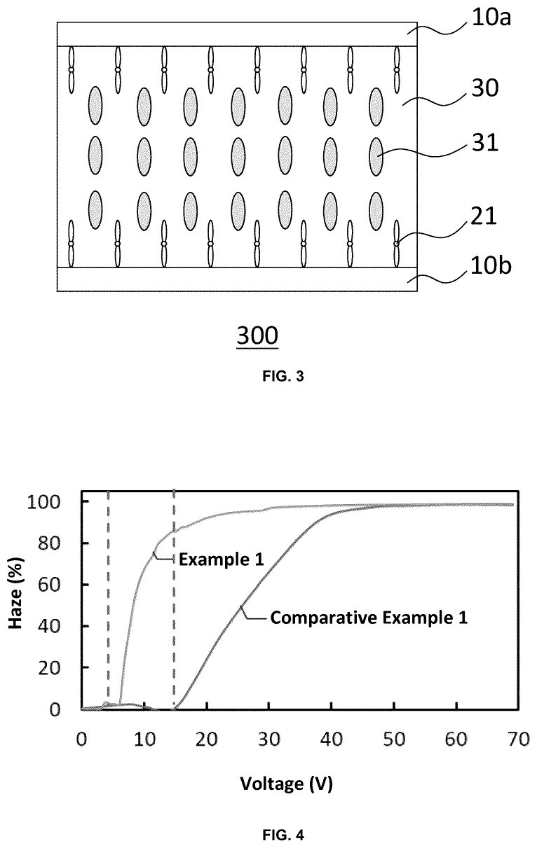

FIG. 3 is a cross-sectional schematic view of a dimming device according to Embodiment 2 of the present invention.

As shown in FIG. 3, a dimming device 300 according to Embodiment 2 of the present invention includes a pair of transparent substrates 10a, 10b and a nematic liquid crystal layer 30 sandwiched between the pair of transparent substrates 10a, 10b.

It should be noted that the dimming device 300 according to Embodiment 2 of the present invention has the same components as those of the dimming device 100 according to Embodiment 1 of the present invention, with the exception that the former uses a nematic liquid crystal layer 30 as the liquid crystal layer. Therefore, the descriptions of the components having the same reference numerals as those appearing in the descriptions of the dimming device 100 according to Embodiment 1 of the present invention will be omitted.

Further, the dimming device 300 according to Embodiment 2 of the present invention has a drive voltage of 25 V or less, and preferably 20 V or less, and more preferably 15 V or less, for providing a haze of 80% or more. The drive voltage in such a range can be said to be the lower drive voltage. On the other hand, the lower limit of the drive voltage is not particularly limited, but it may be 3V or 5V, for example.

The haze and drive voltage can be measured by the methods described in Examples below.

The nematic liquid crystal layer 30 includes a nematic liquid crystal compound 31 and a vertical alignment agent 21. The nematic liquid crystal compound 31 is not particularly limited, and materials known in the art can be used. Further, the anisotropy of the dielectric constant of the nematic liquid crystal compound 31 may be either positive or negative.

As with the dimming device 100, 200 according to Embodiment 1 of the present invention, the dimming device 300 according to Embodiment 2 of the present invention can suitably be used in a reverse mode in which the driving method becomes a transmissive mode in a state where a voltage is not applied and becomes a scattering mode in a state where a voltage is applied, because the vertical alignment agent 21 vertically aligns the nematic liquid crystal compound 32 to the pair of transparent substrates 10a, 10b.

The dimming device 300 in the reverse mode becomes the scattering mode because the orientation of the nematic liquid crystal compound 31 in the nematic liquid crystal layer 30 is spontaneously disturbed by applying a voltage higher than a threshold at which the Frederick transition occurs. This would be caused by the following phenomenon. Impurity ions derived from the vertical alignment agent 21 are present in the nematic liquid crystal layer 30 containing the vertical alignment agent 21. When an AC voltage is applied to the nematic liquid crystal layer 30, negative impurity ions are attracted to the positive side and positive impurity ions are attracted to the negative side. At this time, a local flow is generated in the nematic liquid crystal layer 30. However, when the direction of the electric field is reversed by the AC voltage, the directions in which the respective impurity ions are attracted are also reversed. When such a phenomenon is repeated at a constant frequency, a roll-like electric convection occurs and spreads in a uniform manner, thereby macroscopically forming a stripe pattern. Since the nematic liquid crystal layer 30 has birefringence, a scattering phenomenon occurs due to a difference between refractive indices within the stripe pattern.

It should be noted that the macroscopic stripe pattern also depends on the frequency, and the stripe pattern is formed by driving at 100 Hz, but at 1000 Hz, the stripe pattern is no longer visible regardless of the applied voltage. This supports the fact that, at high frequencies, the impurity ions cannot be followed and moved, so that electrical convection is not generated, which is consistent with the above explanation based on the impurity ions.

On the other hand, that device becomes the transmissive mode because the orientations of the nematic liquid crystal compound 31 in the nematic liquid crystal layer 30 are aligned by stopping the application of the voltage.

It should be noted that the above phenomenon cannot be observed in the conventional dimming devices in which alignment films are formed on the surfaces of the pair of transparent substrates 10a, 10b. Moreover, since this method has a faster response speed than other methods, the transmissive mode and the scattering mode can be switched at a higher speed.

The impurity ion density in the liquid crystal layer (nematic liquid crystal layer 30) is not particularly limited, but it may preferably be 0.3 to 400 nC/cm², and more preferably 1 to 390 nC/cm², and even more preferably 10 to 380 nC/cm², and still more preferably 30 to 380 nC/cm². The control of the impurity ion density to such a range can lead to stable generation of electroconvection upon application of voltage.

The impurity ion density in the liquid crystal layer can be calculated by the following method using an ion density measurement system (from TOYO Corporation).

Since the dimming device 100, 200 according to Embodiment 1 of the present invention use the polymer dispersed liquid crystal layer 20 as the liquid crystal layer, it requires a step for forming the polymer dispersed liquid crystal layer 20. More particularly, it requires the addition of the monomer component necessary for forming the polymer dispersed liquid crystal layer 20 to the liquid crystal composition and the irradiation with the active energy ray to polymerize or crosslink the monomer component. On the other hand, since the dimming device 300 according to Embodiment 2 of the present invention uses the nematic liquid crystal layer 30 as the liquid crystal layer, it does not require the addition of the monomer component and the irradiation with the active energy ray to polymerize or cross-link the monomer component. Therefore, the dimming device 300 according to Embodiment 2 of the present invention can reduce manufacturing costs as compared to the dimming device 100, 200 according to Embodiment 1 of the present invention.

The dimming device 300 according to Embodiment 2 of the present invention having the structure as described above can be manufactured by a method including a step of producing a liquid crystal cell by arranging the liquid crystal composition containing the nematic liquid crystal compound 31 and the vertical alignment agent 21 between the pair of transparent substrates 10a, 10b. The step of producing the liquid crystal cell can be performed according to the method as described above. Further, since the dimming device 300 according to Embodiment 2 of the present invention uses the nematic liquid crystal layer 30 as the liquid crystal layer, the step for forming the polymer dispersed liquid crystal layer 20 as described above is not unnecessary, so that the manufacturing costs can be reduced.

While this specification has described the embodiments where the technique described in this specification is used for the dimming device, this technique can also be used for a liquid crystal display device.

### EXAMPLES

The present invention will be described in detail below with reference to Examples, but the present invention is not construed as being limited thereto.

### Example 1

A dendrimer in which R¹ in the above formula (I) was represented by the following formula was synthesized as follows:

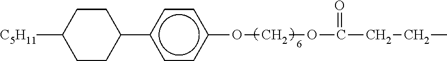

### Synthesis of 6-[4-(trans-4-pentylcyclohexyl)phenoxy]hexanol

To a 200 mL eggplant flask were added 4-(trans-4-pentylcyclohexyl)phenoxyphenol (10 g, 41 mmol), 6-bromohexanol (8.8 g, 49 mmol), potassium carbonate (11 g, 80 mmol) and 2-butanone (50 ml), dissolved, and heated under reflux for 60 hours. At the end of the heating under reflux, the residue obtained by removing 2-butanone under reduced pressure was dissolved in ethyl acetate, and the solution was washed with water three times. Subsequently, to the solution was added anhydrous sodium sulfate, and water was removed, and ethyl acetate was then distilled off under reduced pressure, and the resulting residue was recrystallized with n-hexane to obtain white crystals with a yield of 6.2 g (a yield of 44%). It was confirmed by IR that the white crystals had characteristic absorptions of 3340 cm⁻¹ (OH), 2922 cm⁻¹ (CH) and 1245 cm⁻¹ (PhO—).

### Synthesis of 6-[4-(trans-4-pentylcyclohexyl)phenoxy]hexyl acrylate

To a 200 mL three-necked flask were added 6-[4-(trans-4-pentylcyclohexyl)phenoxy]hexanol (6.0 g, 17 mmol), triethylamine (2.2 g, 22 mmol) and THF (50 ml), dissolved, and cooled on ices to 0° C. To this solution was slowly added acryloyl chloride (1.9 g, 21 mmol) using a syringe and stirred at room temperature for 12 hours. The resulting white solid was filtered off, the resulting filtrate was concentrated under reduced pressure, and the resulting residue was then dissolved in ethyl acetate and washed with 100 mL of water three times. Subsequently, anhydrous magnesium sulfate was added to the organic phase and water was removed, and the resulting mixture was then concentrated under reduced pressure. The residue was then purified by column chromatography (stationary phase: silica gel, mobile phase: hexane/chloroform (volume ratio: 50:1)) to obtain a colorless transparent liquid with a yield of 6.4 g (yield of 93%). It was confirmed by IR that this liquid had characteristic absorptions at 2920 cm⁻¹ (C—H), 1716 cm⁻¹ (C═O) and 1245 cm⁻¹ (PhO—).

### Synthesis of Dendrimer

To a 20 ml eggplant flask were added DAB-Am-8 from Sigma-Aldrich (0.16 g, 0.21 mmol), 6-[4-(trans-4-pentylcyclohexyl)phenoxy]hexyl acrylate (4.0 g, 10 mmol) and THF (5 ml), and heated at 50° C. for 72 hours. Subsequently, this solution was concentrated under reduced pressure, and the resulting residue was then dissolved in a small amount of chloroform and added to 100 ml of methanol, and the resulting supernatant was removed by decantation to recover a precipitate. This operation was repeated twice to obtain a paste-like pale yellow solid with a yield of 0.45 g (a yield of 30%). It was confirmed by IR that the pale yellow solid had characteristic absorptions at 2921 cm⁻¹ (C—H), 1736 cm⁻¹ (C═O) and 1247 cm⁻¹ (PhO—). Also, the elemental analysis value of the pale yellow solid agreed within 0.5% with the value calculated as C₄₅₆H₇₃₆N₁₄O₄₈ (calculated value ˜C: 76.25%, H: 10.33%, N: 2.73%, actual value ˜C: 76.09%, H: 10.52%, N: 2.80%). The molecular weight of the pale yellow solid was measured by MALDI-TOF-MS, and as a result, the actual value was m/Z=7181.2 (M+H), whereas the theoretical value was m/Z=7183 (M+H). Furthermore, DSC measurement of the pale yellow solid was performed. In the heating process, Tg was observed at −24° C., and endothermic peaks were observed at 14° C. and 73° C., and in the cooling process, exotherm peaks were observed at 69° C. and 15° C., and Tg was observed at −26° C.

Next, using the dendrimer synthesized above, a dimming device was produced by the following procedure:

First, the dendrimer was heated to 75° C., and a liquid crystal compound (ZLI-4788-100 from Merck) and a liquid crystal monomer (RM257 from Tokyo Chemical Industry Co., Ltd.) were added and mixed to obtain a liquid crystal composition. In the liquid crystal composition, the mass ratio of the liquid crystal monomer and the liquid crystal compound was set to 20:80, and the content of the dendrimer was set to 1% by mass.

Subsequently, a glass substrate (having a thickness of 1.1 mm) with an ITO transparent electrode was prepared, and a spacer (Mylar film, with a thickness of 6 μm) was sandwiched between the two glass substrates facing the ITO transparent electrode to the inside to obtain a laminate. The liquid crystal composition was then injected into the space between the two glass substrates by using capillary action to obtain a liquid crystal cell.

The liquid crystal cell was then irradiated with an ultraviolet ray. More specifically, the liquid crystal cell was continuously irradiated with the ultraviolet ray at room temperature for 10 minutes using a UV exposure machine equipped with a UV-LED light source at an illuminance of 10 mW/cm². Thus, the liquid crystal monomer was polymerized or crosslinked to form a liquid crystal macromolecule, thereby forming the polymer dispersed liquid crystal layer.

### Comparative Example 1

A dimming device was produced by the same method as that of Example 1, with the exception that the alignment film was formed on the glass substrate with an ITO transparent electrode instead of using the dendrimer. More particularly, a dimming device was produced by the following procedure:

First, a liquid crystal compound (ZLI-4788-100 from Merck) and a liquid crystal monomer (RM257 from Tokyo Chemical Industry Co., Ltd.) were mixed to obtain a liquid crystal composition. In the liquid crystal composition, the mass ratio of the liquid crystal monomer and the liquid crystal compound was set to 20:80.

Then, a vertical alignment film material SE-4811 (from Nissan Chemical Corporation) was applied to the surfaces of the glass substrates (having a thickness of 1.1 mm) with the ITO transparent electrodes on the ITO transparent electrode side, and baked at 200° C. for 30 minutes, and alignment films were then formed by a rubbing process.

Subsequently, a spacer (mylar film, with a thickness of 6 μm) was sandwiched between the two glass substrates facing the alignment film side to the inside to obtain a laminate, and the liquid crystal composition was then applied to the two glass substrates using capillary action to obtain a liquid crystal cell.

The liquid crystal cell was then irradiated with an ultraviolet ray under the same conditions as those of Example 1. Thus, the liquid crystal monomer was polymerized or crosslinked to form a liquid crystal macromolecule, thereby forming polymer dispersed liquid crystal layers.

After placing the dimming device obtained in each of Examples and Comparative Example described above in a haze meter so that the incident light was perpendicular to the glass substrate surface, a voltage of 0 to 70 V was applied to the dimming device, and a total light transmittance and diffuse light transmittance were measured to determine a relationship between a voltage and a haze in the dimming device. The results are shown in FIG. 4.

The haze was calculated using the following equation:

Haze (%)=diffuse light transmittance/total light transmittance×100

Further, the diffuse light transmittance is a transmittance of light diffused by 2.5° or more from the incident light.

As shown in FIG. 4, the dimming device according to Example 1 could achieve a haze of 80% or more at a voltage of 15 V or less, whereas the dimming device according to Comparative Example 1 required a voltage of 30 V or more for achieving a haze of 80% or more. The dimming device according to Comparative Example 1 also had a haze threshold voltage (voltage at which the haze started to change) of 16 V, whereas the dimming device according to Example 1 had a haze threshold voltage of 6 V, indicating that it was also possible to lower the haze threshold voltage.

In order to discuss the above results, the following experiments were conducted:

### (Contact Angle)

The contact angle was measured for the following three samples. For the measurement of the contact angle, a commercially available contact angle meter was used. The same glass substrates with ITO transparent electrodes, liquid crystal compounds, dendrimers, and alignment films as those of Examples and Comparative Examples as described above were used.

Sample 1: The contact angle of the liquid crystal compound with respect to the glass substrate with the ITO transparent electrode was measured.

Sample 2: The contact angle of the mixture of the liquid crystal compound and the dendrimer with respect to the glass substrate with the ITO transparent electrode was measured.

Sample 3: The contact angle of the liquid crystal compound with respect to the glass substrate with the ITO transparent electrode on which the alignment film was formed was measured.

Additionally, in Sample 2, the content of the dendrimer in the mixture was 1% by mass.

Table 1 shows the measured results of the contact angles.

TABLE 1

| Sample | Contact Angle (°) |
|---|---|
| 1 | 2.96 |
| 2 | 20.51 |
| 3 | 49.62 |

As shown in Table 1, Sample 1 had a smaller contact angle and higher wettability of the glass substrate with the ITO transparent electrode (hereinafter abbreviated as “substrate”). Further, Sample 3 had a larger contact angle, and had a decreased wettability of the substrate because it formed the alignment film on the substrate. On the other hand, Sample 2 had a smaller contact angle than that of Sample 3 and had higher wettability of the substrate than that of Sample 3.

In a polymer dispersed liquid crystal, a macromolecular network at a substrate interface would become sparse and a dense macromolecular network would be formed at a bulk portion, if the wettability of the substrate is lower. Therefore, it is believed that in the dimming device according to Comparative Example 1 in which the alignment films were formed, the macromolecule network at the bulk portion of the polymer dispersed liquid crystal layer became dense, and the voltage for achieving a haze of 80% or more and the haze threshold voltage became higher. On the other hand, it is believed that in the dimming device according to Example 1 in which the alignment film was not formed, the macromolecule network at the substrate interface became denser than that at the bulk portion, so that the voltage for achieving a haze of 80% or more and the haze threshold voltage could be lowered.

### (Observation of Substrate Surface by Laser Microscope and Scanning Electron Microscope (SEM))

The surfaces of the substrates for the following two samples were observed with a laser microscope (VK-9710 from Keyence Corporation) and a scanning electron microscope.

Sample 1: The liquid crystal composition used in Example 1 was injected between a glass substrate and a polycarbonate substrate (SS80 from Teijin Limited), and then irradiated with the ultraviolet ray under the same conditions as those of Example 1. The polycarbonate substrate was then peeled off, the liquid crystal compound and dendrimer were removed, and the surface of the glass substrate was then observed with a laser microscope and a scanning electron microscope.

Sample 2: The liquid crystal composition used in Comparative Example 1 was injected between a glass substrate having the same alignment film as in Comparative Example 1 and a polycarbonate substrate (SS80 from Teijin Limited), and then irradiated with the ultraviolet way under the same conditions as those of Comparative Example 1. The polycarbonate substrate was then peeled off, the liquid crystal compound was removed, and the surface of the glass substrate was then observed with a laser microscope and a scanning electron microscope.

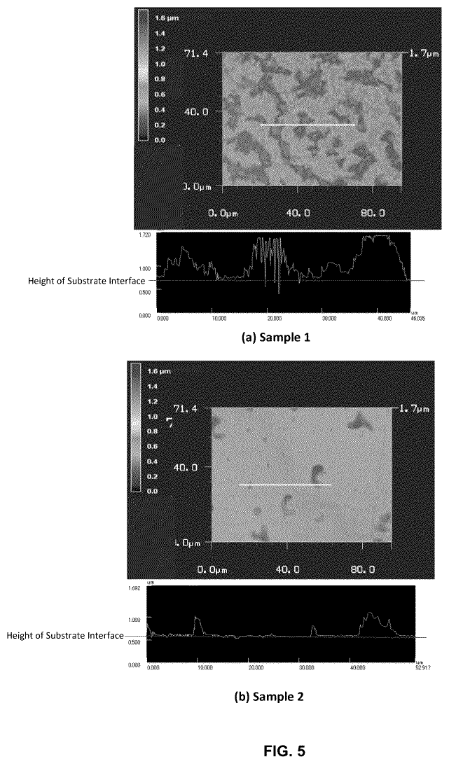

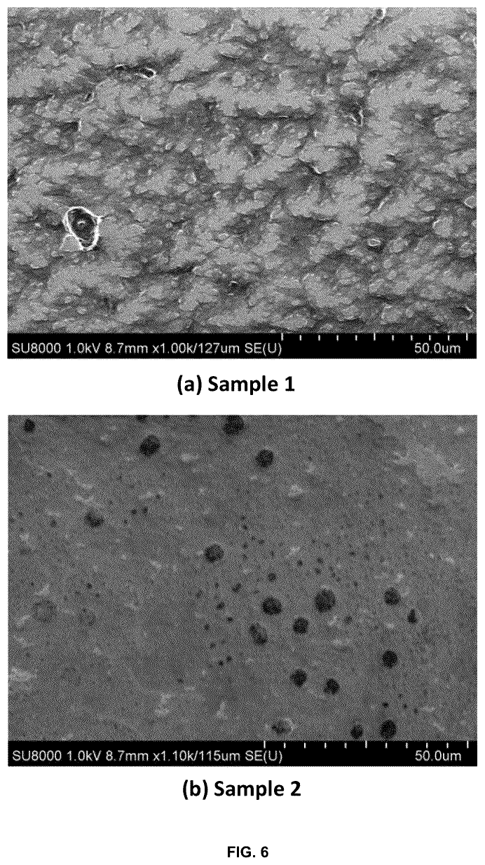

FIG. 5 shows an image of the surface of the substrate observed by the laser microscope, and FIG. 6 shows an image of the surface of the substrate by the scanning electron microscope.

As shown in FIGS. 5 and 6, Sample 1 had densely formed polymer lumps on the surface of the substrate as compared to Sample 2.

These observation results of the surfaces of the substrates show that the dimming device according to Example 1 in which the alignment film is not formed results in the denser macromolecule network at the substrate interface and in the sparser macromolecule network at the bulk portion than the dimming device according to Comparative Example 1 in which the alignment films are formed. It is believed that the dimming device according to Example 1 resulted in decreased alignment regulating force of the macromolecule network at the bulk portion, so that the voltage required to achieve a haze of 80% or more and the haze threshold voltage could be lowered.

### Example 2

Using the dendrimer synthesized in Example 1, a dimming device was produced according to the following procedure:

First, a dendrimer and a nematic liquid crystal compound (ZLI-4788-100 from Merck) were mixed to obtain a liquid crystal composition. In the liquid crystal composition, the dendrimer content was set to 1% by mass.

Then, a glass substrate (20 mm×25 mm×1.1 mm in thickness) with an ITO transparent electrode was prepared, and a spacer (mylar film, with a thickness of 5 μm) was sandwiched between the two glass substrates facing the ITO transparent electrodes to the inside to obtain a laminate. The liquid crystal composition was heated to 140° C. where it formed an isotropic phase, and then injected between the two glass substrates using capillary action, and cooled to room temperature to obtain a liquid crystal cell (a dimming device).

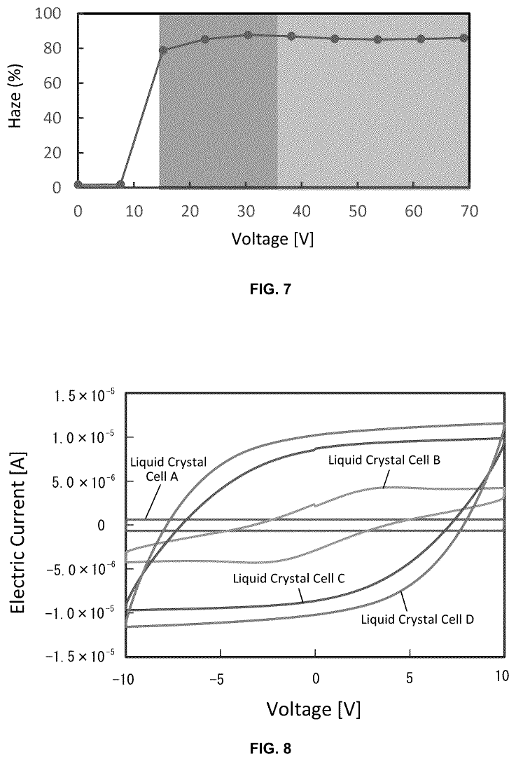

After placing the dimming device obtained in Example 2 in a haze meter so that the incident light was perpendicular to the glass substrate surface, the total light transmittance and diffuse light transmittance were measured by the same method as that of Example 1 to determine the relationship between voltage and haze in the dimming device. The results are shown in FIG. 7.

As shown in FIG. 7, the dimming device according to Example 2 could achieve a haze of 80% or more at a voltage of 15 V or less.

In order to discuss the above results, the following experiment was conducted:

### (Impurity Ion Density in Nematic Liquid Crystal Layer)

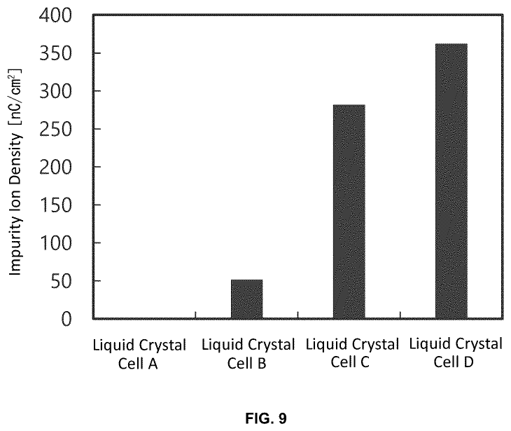

A triangular wave voltage with a frequency of 10 Hz and an amplitude of 10 V was applied to the following four liquid crystal cells using an ion density measurement system (from TOYO Corporation). The results (graph of current waveform versus applied voltage) are shown in FIG. 8. Also, in the graph of FIG. 8, the impurity ion density was calculated from the current peak. The calculation method is described in Masaru INOUE, “Fundamentals and Applications of Electrical Characteristic Measurement of Liquid Crystal Cells (1) [Basic Edition]”, Liquid Crystal, Vol. 13, No. 1, pp. 68-74, 2009. The results are shown in FIG. 9.

Liquid crystal cell A: A liquid crystal cell produced by the same method as that of Example 2, with the exception that no dendrimer was added;

Liquid crystal cell B: Liquid crystal cell produced in Example 2;

Liquid crystal cell C: Liquid crystal cell produced by the same method as that of Example 2, with the exception that the dendrimer content was changed to 3% by mass;

Liquid crystal cell D: liquid crystal cell produced by the same method as that of Example 2, with the exception that the dendrimer content was changed to 5% by mass.

As shown in FIG. 8, in the liquid crystal layers B to D provided with the nematic liquid crystal layers each containing the dendrimer, a current waveform showing the presence of impurity ions was confirmed, whereas in the liquid crystal layer A provided with the nematic liquid crystal layer containing no dendrimer, the current waveform showing the presence of impurity ions was not observed. Also, as shown in FIG. 9, it was confirmed that the higher the dendrimer concentration, the higher the impurity ion density. From these results, it is believed that the impurity ions derived from the dendrimer generate electrical convection when the voltage is applied, and cause the scattering phenomenon.

As can be seen from the above results, according to the present invention, it is possible to provide an inexpensive dimming device with a lower drive voltage, a manufacturing method thereof, and a smart window.

### [License Declaration]

When this patent application is granted, in principle, we will flexibly consider that an exclusive license is given or a share is transferred to one who wishes to utilize the patent. If you wish to obtain a license or the like, please contact the representative for this patent application.

### DESCRIPTION OF REFERENCE NUMERALS

10a, 10b transparent substrate
20 polymer dispersed liquid crystal layer
21 vertical alignment agent
22 liquid crystal compound
23 partition wall
30 nematic liquid crystal layer
31 nematic liquid crystal compound
100, 200, 300 dimming device

1. A dimming device comprising a pair of transparent substrates and a liquid crystal layer sandwiched between the pair of transparent substrates,
wherein the liquid crystal layer comprises a vertical alignment agent, and
wherein the dimming device has a drive voltage of 25 V or less for providing a haze of 80% or more.

2. The dimming device according to claim 1, wherein the drive voltage for providing the haze of 80% or more is 20 V or less.

3. The dimming device according to claim 1, wherein the drive voltage for providing the haze of 80% or more is 15 V or less.

4. The dimming device according to claim 1, wherein the liquid crystal layer is a polymer dispersed liquid crystal layer.

5. The dimming device according to claim 4, wherein the polymer dispersed liquid crystal layer comprises a partition wall for partitioning the polymer dispersed liquid crystal layer into a plurality of regions.

6. The dimming device according to claim 1, wherein the liquid crystal layer is a nematic liquid crystal layer.

7. The dimming device according to claim 4, wherein an impurity ion density in the liquid crystal layer is 0.3 to 400 nC/cm².

8. The dimming device according to claim 1, wherein the vertical alignment agent is a macromolecule having a branched structure comprising at least one mesogenic group in at least one side chain, and wherein the macromolecule comprises one or more atoms that can be adsorbed to the transparent substrate by intermolecular force.

9. The dimming device according to claim 1, wherein the liquid crystal layer further comprises a dichroic dye.

10. The dimming device according to claim 1, wherein the pair of transparent substrates are not provided with an alignment film on each surface on the liquid crystal layer side.

11. The dimming device according to claim 1, wherein the pair of transparent substrates are a glass substrate and/or a resin substrate.

12. The dimming device according to claim 1, wherein a drive method of the dimming device is a reverse mode.

13. A method for manufacturing the dimming device according to claim 1, the method comprising:
a step of producing a liquid crystal cell by arranging a liquid crystal composition comprising a liquid crystal compound and a vertical alignment agent between a pair of transparent substrates.

14. The method for manufacturing the dimming device according to claim 13, wherein the liquid crystal composition further comprises at least one monomer component, and the method further comprises a step of irradiating the liquid crystal cell with an active energy ray.

15. The method of manufacturing the dimming device according to claim 14, wherein the at least one monomer component comprises a liquid crystal monomer.

16. The method for manufacturing the dimming device according to claim 14, wherein the irradiation with the active energy ray comprises a first irradiation with an active energy ray for selectively irradiating a predetermined portion of the liquid crystal cell, and a second irradiation with an active energy ray for irradiating the entire surface of the liquid crystal cell.

17. The method for manufacturing the dimming device according to claim 13, wherein the liquid crystal compound is a nematic liquid crystal compound.

18. A smart window comprising the dimming device according to claim 1.
